(19) United States
(12) Patent Application Publication
(10) Pub. No.: US 2024/0160165 A1
(43) Pub. Date: May 16, 2024

(54) Method and System for Predicting Operation of a Technical Installation

(71) Applicant: Siemens Aktiengesellschaft, Muenchen (DE)

(72) Inventors: Thomas BIERWEILER, Stutensee (DE); Daniel LABISCH, Karlsruhe (DE)

(21) Appl. No.: 18/282,593

(22) PCT Filed: Mar. 17, 2022
(86) PCT No.: PCT/EP2022/057083

§ 371 Date: Sep. 18, 2023

(30) Foreign Application Priority Data
Mar. 19, 2021 (EP) 21163758.2

(51) Int. Cl. G05B 13/04; G05B 13/02

(52) U.S. Cl. CPC G05B 13/048; G05B 13/027

(57) ABSTRACT

Method and system for predicting the operation of a technical installation in which a process-engineering process having a process step runs, wherein datasets are acquired and stored in a memory and, during a learning phase, a self-organizing map is learned, symptom threshold values and associated tolerances are ascertained and stored for each neuron per SOM and all permissible temporal profiles of victor neurons are ascertained and stored per process step or batch for all timestamps, where a time starting from which operation of the technical installation should be predicted is determined during an evaluation phase, a victor neuron profile for the overall process step or batch is ascertained using current datasets of a process step via learned victor neuron profiles, and values, stored in neurons of this victor neuron profile, of the process variables are displayed after the previously determined time as a predicted profile.

### CROSS-REFERENCE TO RELATED APPLICATIONS

This is a U.S. national stage of application No. PCT/EP2022/057083 filed 17 Mar. 2022. Priority is claimed on European Application No. 21163758.2 filed 19 Mar. 2021, the content of which is incorporated herein by reference in its entirety.

### BACKGROUND OF THE INVENTION

### 1. Field of the Invention

The invention relates to a computer program, computer program product, a method and system for predicting the operation of a technical installation in which a process engineering process having at least one process step runs.

### 2. Description of the Related Art

The operation of process engineering production installations is influenced by a plurality of process step parameters, operating parameters, production conditions, installation conditions and settings. A few of these influencing variables can be predetermined by the installation operator or by the automation, others, although they cannot be influenced, can be measured, and above and beyond this yet other unknown influences have an effect. In addition, the process frequently involves great complexity, so that the effect of changing an influencing variable is not known in advance. In order to avoid unfavorable operating states, ongoing supervision at least via a process control system and frequently also by additional systems is performed. Smaller deviations may possibly only result in lower quality, larger deviations can already lead to production outages or can even represent a safety risk. As well as the supervision of the current installation state, there is also frequently the desire to predict the future behavior, in order in this way to be able to react even earlier to the threat of deviations. Predictions of the future behavior of the process are also desirable in the area of predictive maintenance of technical installations.

The simplest possibility of a prediction is provided by extrapolation of the current behavior into the future. Here, depending on process dynamics, the most recent past is taken into account and extrapolated into the future. In this case, however, many effects from the earlier past remain unconsidered, so that the result is mostly not informative. In order to be able to predict the behavior of a production installation reliably, the simulation of a dynamic process model is usually employed. As a rule, a usable quality can only be obtained via rigorous modeling of the process. The models, in this case, are frequently non-linear and need a large quantity of dynamic variables. The modeling required generally requires a great deal of effort, which in many application cases is not worthwhile. Moreover, the process model must still be supplemented by the installation model, in particular by models of automation and closed-loop control, in order to also be able to reproduce the real behavior. Overall, simulation-based predictions are therefore only realized in few application cases, and this occurs where the high financial outlay involved is worthwhile.

As an alternative, simulation models can also be learned based on data. Established identification methods only exist, however, for the large part for linear dynamic models. These can, however, only satisfactorily map complex processes in the vicinity of a work point. The data-based identification of a general non-linear dynamic model is, however, barely possible, because without a predetermined structure for the model a practically infinite multiplicity of possible variations is produced. The use of data-based simulation models is therefore restricted to linear systems, which are largely explicitly supplemented by individual non-linearities.

### SUMMARY OF THE INVENTION

In view of the foregoing, it is therefore an object of the present invention, for dynamic, in particular discontinuous processes, to provide a data-based method and system for predicting the operation of a technical installation that eliminates the need to provide expensive modeling of complex non-linear dynamic processes and in addition exhibits a high reliability. From this starting point, the underlying object of the invention is to specify a suitable computer program, computer program product and a graphical user interface.

This and other objects and advantages are achieved in accordance with the invention by a method, a system for predicting operation of a technical installation in which a process engineering process having at least one process step is executing, a computer program, a computer program product and a graphical user interface which is displayed on a display unit, and which is configured to display predicted profiles of the system.

On condition that historical data of the process step is present, a prediction of the future dynamic process behavior with the aid of SOMs is proposed below in accordance with the invention.

A self-organizing map (abbreviated to SOM) is a type of artificial neural network that is trained by an unsupervised learning process, in order to create a two-dimensional, discretized mapping of the input space of the learned data, which is referred to as a map. These maps are useful for the classification and visualization of low-dimensional views of high-dimensional data, as are present in the process industry. The map consists of neurons or nodes in a specific topology (for example, 6×8 neurons arranged in the form of a matrix). Each neuron corresponds to a vector or n-tuple of the dimension n×1, where the dimension of the vector corresponds, for example, to the number n of the input signals. The data of a vector can, for example, involve process step variables, such as temperature, pressure, and/or air humidity and also adjustment variables, setpoint values or measurable noise variables, i.e., all variables that are directly related to the process engineering process and thus form a data set that characterizes a process state. An SOM thus represents a mapping of the process behavior. If SOMs are trained with “good data”, then they represent the normal behavior of the process. Basically, however, the training of an SOM with “bad data” is also possible, in order to map an incorrect behavior of the process. This means that with SOMs any process behavior can be represented. The only requirement here is that the learning data is representative for all methods of operation and events occurring in operation.

This implicit knowledge present in the SOM on the basis of the learned data is now used in accordance with the invention to predict the profile of a process. This is possible both for a continuous process and also for batch process with a number of process steps, which are operated in a batch-oriented way according to ISA-88, for example, with the aid of sequential functional controls (SFC) or also series of steps.

The invention accordingly relates to a method and system for predicting the operation of a technical installation, in which a process engineering process is running with at least one process step, where data sets characterizing the operation of the installation with values of process step variables are acquired in a time-dependent manner and stored in a data memory and a self-organizing map (SOM) is learned in a learning phase using historical data sets for each process step or batch, for each SOM symptom threshold values and their tolerances are ascertained for each neuron and stored and for each process step or batch for all time stamps, all allowable, temporal execution sequences of winner neurons are ascertained and stored. In accordance with the invention, during an evaluation phase, a point in time is determined starting from which a prediction of the operation of the technical installation is to occur, using current data sets of at least one process step via the winner neuron execution sequences are subsequently learned, at least one winner neuron execution sequence is ascertained for the entire process step or batch and the values of the process variables stored in the neurons of this winner neuron execution sequence after the previously determined point in time are displayed as the predicted execution sequence on an output unit.

There are numerous advantages to the inventive method and system. On the one hand, the prediction of the future dynamic process behavior makes it possible for an installation operator to make early corrective interventions into the operation of a technical installation when, for example, deviations from normal operation can be detected in the predicted execution sequences. On the other hand, deviations between actual and predicted behavior make it easier to find the causes of anomalies that occur. Accordingly, the method can be combined with anomaly recognition. If the current data sets do not match the SOM or the profile of the winner neurons, then the current behavior is deviating from the learned behavior. This can be reported as an anomaly.

Unlike in the simulation of a rigorous process model, the effort of modeling is dispensed with completely. The initial learning process step of the SOM can be advantageously completely automated, so that no parameters have to be prespecified by the user. By contrast, with data-based linear dynamic models, the SOM, in conjunction with the profiles, can also map a complex non-linear behavior. The invention is particularly suitable for batch processes. As a result, the invention can advantageously be used within the pharmaceutical industry in the production of medicines or vaccines.

The individual steps of the inventive method are explained in detail below.

In the learning phase, using historical data sets for each process step or batch, a self-organizing map (SOM) is learned.

In the learning phase, for each neuron (=node) of the self-organizing map, the n-tuple (=data sets with the corresponding values of the process variables characterizing a specific operation of the installation) of the neurons is calculated and is stored in a data memory. All neurons of the map represent, after the learning phase, a typical state of the learning data, where in general none of the neurons corresponds exactly to an actual state. The values of the n-tuples of the neurons are determined after the learning phase. The size of the map, i.e., the two-dimensional arrangement of the neurons, can be defined in advance or manually or automatically optimized and adjusted during the learning phase. To this end, in a first step, a plurality of SOMs is initialized at random, from which the best map, i.e., the map with the smallest measure of distance to each neuron, provided all neurons are involved, is sought (the term “hit” means that the amount of the difference is formed from the learning data vector and the data set of a neuron. The neuron with the smallest difference consisting of learning data vector and the data set of the neuron is the “hit” neuron). Further criteria, such as the minimum number of multiple hits of the training data, can be used. An iterative method can further also be used, in which with one map size, many SOMs are initialized and learned at random and subsequently, with the aid of the training data, the number of hits per neuron is ascertained. Thereafter, depending on the number of hits, whether the map is too large or too small is repeatedly ascertained. The iteration is continued until such time as the largest map, which is just not too large, is found. This method of the operation optimal prerequisites for an optimal process prediction are created. An almost optimal map size increases the efficiency of the method and prevents unnecessary computing times (through the evaluation of neurons not hit in any event).

In a next step of the learning phase symptom threshold values and their tolerances are ascertained for each neuron and stored for each SOM.

A symptom threshold value involves the difference consisting of a training data set (or test vector) and the data set that characterizes the neuron considered. The symptom threshold value is expressed by a vector of the dimension of the neuron. The symptom threshold is determined for each signal. For example, the threshold value for each signal can amount to 0.15+0.03 tolerance. The symptom threshold value accordingly specifies how large at a particular point in time the difference between a training data set and the data set that characterizes the neuron being considered may be. Accordingly, each value of the n-tuple of the neuron of the SOM possesses its own threshold value (symptom threshold value). If good data is used as training data and the threshold value is chosen relatively small, then the data sets considered are very similar to the good data, i.e., to the data set stored in the node of the SOM for normal operation. The threshold value is thus decisive for the quality of the display of the uncertainty of the prediction, i.e., for the quality of the band of trust.

For each process step or batch (which consists of a number of process steps), subsequently in the learning phase all permitted, temporal profiles of winner neurons are ascertained and stored for all time stamps.

This means that for each point in time of a process step or batch for a test vector or representative data set (for example, a good data set, which represents normal operation) the distance to each neuron of the map is determined. The neuron, for which the distance to the good data set is minimal, is the winner neuron. If this minimal measure of distance is ascertained time stamp by time stamp, then a temporal time sequence of the winner neurons, the “winner neuron profile” or also reference path is produced. Optionally for these profiles in accordance with the invention, the condition of neuron similarity is also fulfilled. The neuron similarity involves all neurons for which the distance of a representative data set to the winner neuron lies within the symptom tolerance of this neuron. Thus, for each time stamp, a number of permitted winner neurons are produced and thus, taking into account the time dependence in total a plurality of winner neuron profiles. These winner neuron profiles are determined and stored separately for each SOM and thus for each process step or batch.

After this step, for the process step considered (or the entire batch process), the learning phase is completed. The learning or also training of an SOM plays an important part for the inventive method and system, because here the knowledge necessary for the “look into the future” is mapped via the process step in the SOM, the winner neurons and the winner neuron profiles. If now, in an evaluation phase, a point in time within this process step or batch is determined, starting from which a prediction of the operation of the technical installation is to occur, based on the known learned knowledge for current data sets, then the future behavior can be predicted. The term “future” here always refers to the period of time after the point in time previously determined. Depending on how this point in time is selected, this period of time can also lie in the past.

Now, in the evaluation phase, instead of being determined with historical data sets of a process step or batch, the actual profiles of the winner neurons are determined with current data sets of this process step or batch to be supervised, i.e., at least one winner neuron profile is ascertained for the entire process step or batch using current data sets of this process step or batch via the winner neuron profiles learned. The winner neuron is ascertained time stamp by time stamp. This means that, for each time stamp for the current data set, the distance to each neuron of the map is determined. The neuron for which the distance of the current data set is minimal is the winner neuron. Subsequently, a check is made as to whether the winner neuron is located on one of the permitted winner neuron profiles ascertained in the learning phase. This winner neuron profile (of the entire process step or of the entire batch) is then used for prediction. Accordingly, all steps for evaluation up to the previously determined point in time (at which the prediction is to begin, i.e., the start time of the prediction) are performed. The values of the process variables after the previously determined point in time stored in the neurons of this winner neuron profile are then displayed as the predicted profile on an output unit.

The respective symptom tolerances of the neurons of the previously ascertained winner neuron profile can be used, in an advantageous embodiment, as uncertainty for the display of the predicted profile. An uncertainty refers to the case in which a number of relevant states can be present. An installation operator advantageously thus obtains a choice of alternative states, which allows them to better estimate how a specific process variable will develop. When critical values occur, even within a band of uncertainty (or band of trust), this can be a pointer to critical states and an installation operator can react all the more quickly.

If in the evaluation phase a number of winner neuron profiles are ascertained, in an especially advantageous embodiment, the most probable of the winner neuron profiles is determined. This occurs by ascertaining the symptoms of all past time stamps of this process step or batch. A symptom relevant for a current time stamp is determined by the difference consisting of the data set of the current time stamp to the previously determined neuron to be compared being formed, where only the differences of process variables are considered that exceed a predetermined threshold value. The advantage lies in the fact that it now possible to verify whether the winner neurons ascertained for each time stamp are located so to speak on the “right” winner neuron profile, i.e., the neuron profile that is closest to the reality. In this case, the neuron similarity can also optionally be taken into account, i.e., a check is made as to whether the distance of a data vector to the winner neuron lies within the symptom threshold values of all neurons from the profiles stored in the learning phase at the current point in time. The most probable permitted winner neuron profile is thus used for the display of the predicted profile of process step, which greatly enhances the accuracy of the inventive prediction method.

Within the framework of a further preferred embodiment of the inventive method and system, instead of the symptom threshold value or in addition to the symptom, threshold values quantization errors are ascertained via the training data and used in the evaluation for the ascertainment of the most probable winner neuron profile.

The quantization error is a measure of distance to the respective neuron and is calculated as the amount of the difference between the winner neuron and the data set considered. In other words, a current process step of an ongoing operation is now considered. This is now compared with all neurons of the SOM, i.e., the Euclidian distance between the process step and all neurons is determined. For the neuron with the smallest Euclidian step, it is subsequently looked at whether the distance value lies below the threshold value for this neuron. This distance is also referred to as a quantization error. This is precisely so large that, for example, in the case of good data considered, all good data is still classified as good. In the consideration of the quantization errors that are produced with the good data, it is likewise possible to make use of these values for determination of threshold values for the neurons of a map. Tolerances can also be included here. Quantization errors and the amount of the symptom threshold values are thus scalars, which characterize the distance between a data vector (or data set) and a data set of a neuron to be compared.

The use of the quantization error, although less robust than evaluation via the individual symptoms, requires less computing power, however, and thus advantageously makes the inventive method faster.

In a further advantageous embodiment, the union set of all symptom tolerances of all winner neuron profiles of the process step or batch ascertained in the evaluation phase are used as uncertainty of the predicted profile. This thus contains all future profiles possible as seen by the method, so that the installation operator can assess the future behavior with even greater certainty.

Basically, the prediction ends with the end of the current process step. If, however, the winner neuron profiles have been stored for an entire batch, consisting of a number of process steps, then a prediction for the subsequent steps is also possible. In an especially advantageous embodiment, a point in time is defined at which the prediction of the operation of the technical installation is to end. This allows an installation operator to select specific time intervals for the prediction that require particular attention, for example, because in this time interval in the past a significant process step or an alarm or a specific event has occurred.

In a further advantageous embodiment of the invention, a configurable selection of the predicted temporal profiles of the process steps, step identifiers, anomalies and/or symptoms are shown simultaneously and/or in correlation with one another as temporal profiles on a display unit. The supervision of the process engineering process step is facilitated in this way for an installation operator or the user of an inventive software application. In order to be able to work with the results shown at handling a problem efficiently, a configurable selection of the results is especially advantageous. Through an appropriate display, installation operators can act quickly in critical situations and avoid an error occurring. A rapid interaction can save both costs and time and also avert greater dangers.

The objects and advantages in accordance with the invention are also achieved by a system for prediction of the operation of a technical installation, which is configured such that at least one unit for training SOMs, for storage of relevant data and a unit for evaluation of current data sets with the aid of the previously trained SOMs is provided.

The term system can involve both a hardware system such as a computer system consisting of servers, networks and memory units and also a software system such as a software architecture or a larger software program. A mixture of hardware and software is also conceivable, for example an IT infrastructure such as a Cloud structure with its services. Components of such an infrastructure are usually servers, memories, networks, databases, software applications and services, data directories and data management systems. In particular virtual servers likewise belong to a system of this type.

The inventive system can also be part of a computer system, which is located spatially separated from the location of the technical installation. The connected external system then advantageously features the evaluation unit, which can access the components of the technical installation and/or the data memory linked to it, and which is configured to visualize the results of the diagnosis and transmit them to a display unit. In this way, for example, there can be a coupling to a Cloud infrastructure, which further enhances the flexibility of the overall solution.

Local implementations on computer systems of the technical installation can also be advantageous. Thus, an implementation, for example, on a server of the process steps, in particular for safety-relevant process steps, is especially suitable.

The inventive method is thus preferably implemented in the form of software or in the form of a software/hardware combination, so that the invention also relates to a computer program with program code instructions executable by a computer for implementation of the diagnostic method. In this context, the invention also relates to a computer program product, in particular a data medium or a storage medium, with such a computer program that is executable by a computer. Such a computer program, as described above, can be loaded into a memory of a server of a process control system, so that the supervision of the operation of the technical installation can be performed automatically, or the computer program can be held for a Cloud-based supervision of a technical installation in a memory of a remote-service computer or can be loaded into the memory.

The objects and advantages in accordance with the invention are correspondingly achieved by a graphical user interface (GUI), which is displayed on a display unit, and which is configured to show the predicted profiles of disclosed embodiments of the inventive system.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

The invention will be described and explained in more detail below with the aid of the figures and with the aid of an exemplary embodiment, in which:

FIG. 1 shows a schematic diagram of the inventive system for prediction;

FIG. 2 shows an exemplary display of predicted profiles of a few process variables on a display unit; and

FIG. 3 is a flowchart of the method in accordance with the invention.

### DETAILED DESCRIPTION OF THE EXEMPLARY EMBODIMENTS

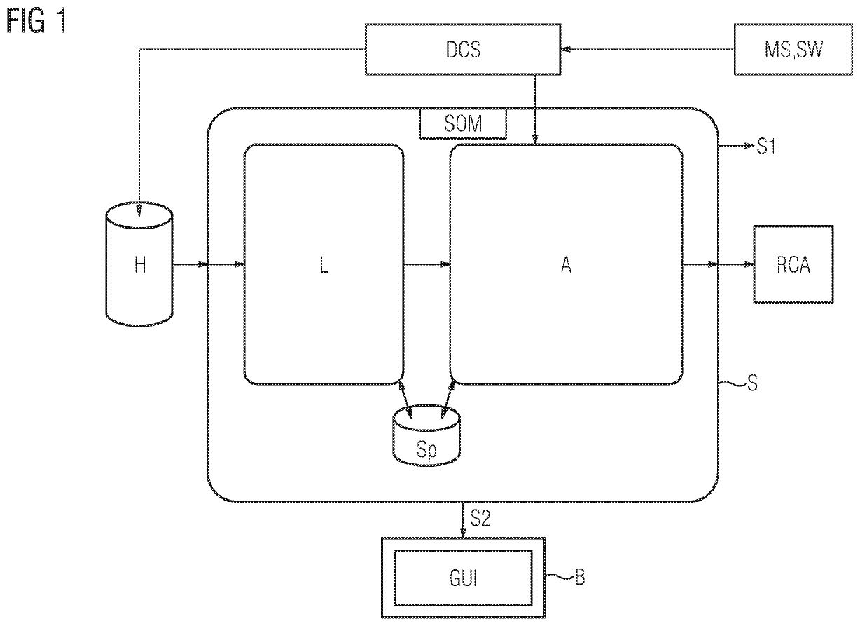

Shown in FIG. 1 is a schematic diagram to explain the inventive system S for prediction, in which an automation system or a process control system DCS controls, regulates and/or supervises a process engineering process. For control of the process, the process control system DCS is connected to a plurality of field devices (not shown). Measurement transducers serve to acquire process variables, such as temperature T, pressure P, throughflow amount F, fill level L, density or gas concentration of a medium, which are mostly detected by sensors and thus correspond to measured values MS. Actuators enable the process control system to be influenced as a function of process variables acquired, for example, according to the specifications of the automation program, which are expressed in setpoint values SW. A closed-loop control valve, a heater or a pump might be mentioned as examples of actuators. For supervision of the operation of the installation a plurality of data sets, which are characteristic for the operation of the installation, are acquired as a function of the time t and in this exemplary embodiment are stored in a data memory H (frequently an archive). Time-dependent here means at specific individual points in time or with a sampling rate at regular intervals or also practically continuously. Thus, the process variables with the respective time stamps are included in the data sets, such as for the temperature: T=(T (t1), T(t2), T(t3) . . . T(tN))^{T} where N represents any given natural number and corresponds to the number of time stamps of a process step. There can be a number of process steps in a batch process, which each characterize a specific phase of the process, such as heating the reactor, stirring within the reactor and also cooling of the reactor. This process would thus consist of 3 process steps.

With the system S, the data sets, which contain values of process variables with corresponding time stamps, are evaluated to show future temporal profiles of process steps, so that where necessary suitable measures can be taken for error handling.

In the illustrated embodiment, the diagnosis system S essentially comprises a unit L for training the self-organizing maps, a unit Sp for storing the variables necessary for implementing the method and a unit A for evaluating the current data sets of a process step or batch with the aid of the self-organizing map trained in the learning phase. Depending on their configuration these units can also be grouped together as one unit or can be configured in various other embodiments, depending on implementation.

Output signals of the system can be supplied to further systems, such as a further process control system or parts thereof, or can be used for further processing (signal S1). Output signals of the system can further be forwarded for visualization on an output unit B (signal S2), provided the system does not comprise such a unit itself. The display unit B can be linked directly to the system or, depending on implementation, for example, can be linked via a data bus to the system. The display unit B can also involve an operating or supervision device of a process control system. At the graphical user interface of the operating or supervision device, changes to the self-organizing map, to the threshold values or to other parameters can be made by an operator if desired.

The unit L for training the self-organizing maps (SOM) uses historical data sets with time-dependent measured values of process variables (as n-tuple) for this purpose and is linked to the data memory H for this purpose. The unit L can advantageously be operated offline, because the learning process is computer-intensive. This is because, for learning the self-organizing maps, numerous historical profiles of process steps are to be recorded. As well as the learning of the maps, threshold values, winner neuron profiles and further variables are determined in the initial learning phase and stored in the memory Sp for further use.

The unit A for evaluating the current data sets of a process step or batch with the aid of the self-organizing maps trained in the learning phase can be operated online, for example, in order to support the operator of an installation in the supervision of the state of the installation. Here, the possibility exists to evaluate the current process values from the process control unit DCS through the inventive method.

The evaluation unit A or the system S can optionally also be linked to a unit RCA for ascertaining further causes, at which, for example, comparisons between the predicted and actual profiles of the process variables can be performed, based on which a further diagnosis such as information about anomalies can be made.

The system S for performing the inventive method can, for example, also be realized in a client-server architecture. Here, the server is used to provide certain services, such as the inventive system, for processing a precisely defined task (here the process variable prediction). The client (here the display unit B) is capable of requesting and making use of the corresponding services from the server. Typical servers are web servers for providing web page contents, database servers for storing data or application servers for providing programs. The interaction between the server and client is undertaken via suitable communication protocols such as http or jdbc.

In a further embodiment, the system S or parts thereof can basically also be formed in an automation environment as a software functional component. This applies especially to the evaluation unit A, because it needs considerably fewer resources (computing power and memory requirement) than the learning unit L with its rather extensive learning algorithms and therefore is also suitable for an implementation at the field and automation level.

The method for installation supervision does not involve any safety-relevant or time-critical functions of a control system. Consequently, as an alternative, the possibility also exists of collecting the data of the process in the control system and “archiving” it on a server, which undertakes the actual analysis. A further possibility is the use of a Cloud environment (for example, the MindSphere) or as an on-premise solution the direct storage of the data on a specific database server at the control system level.

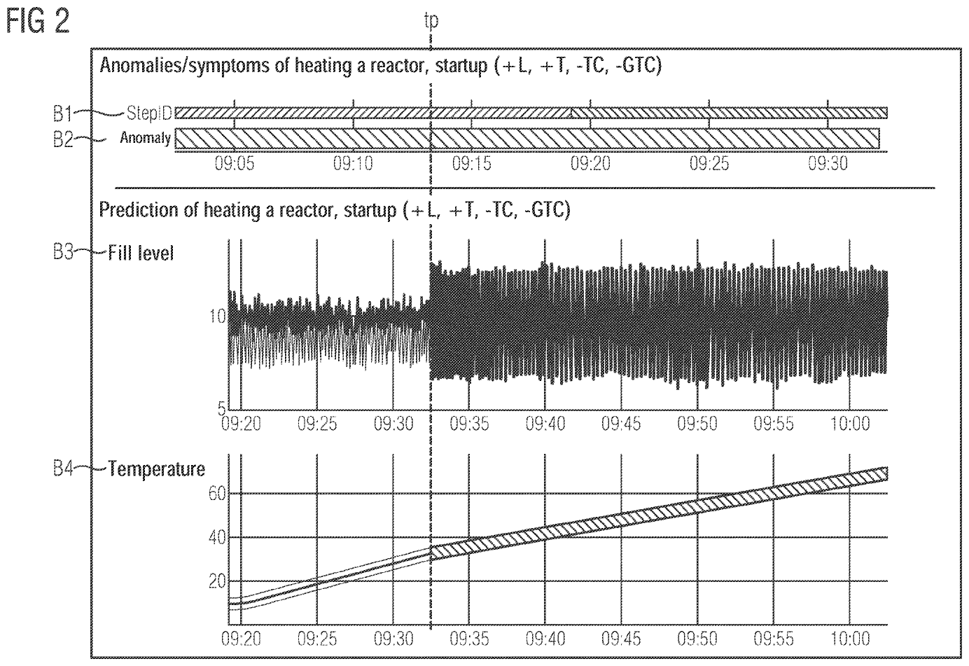

FIG. 2 shows an overview, visual representation of the results of the system S in the form of a trend diagram as a function of the time t. Bars are further shown, which are related to specific process information and frequently are shown in specific colors, which is intended to assist the operator in recognizing critical situations more quickly. The topmost bar StepID (reference character B1) identifies the respective process step. The bar B2 arranged below this identifies the presence of an anomaly. It can, for example, be shown in green or lightly shaded for normal operation and red or heavily shaded for the presence of a deviation from normal operation.

Show below the bars are the temporal profiles of process variables of a reactor. The reference character B3 identifies the temporal profile of the fill level of the reactor and the reference character B4 identifies the temporal profile of the temperature of the medium located in the reactor. In this case, respectively up to the point in time tp (here 9:32), which was defined beforehand, the actual current profiles are shown and after the point in time tp the profiles predicted via the inventive method of the fill level and the temperature. The uncertainties computed via the symptom threshold values are clearly to be seen with the aid of the widened curve profiles.

It should be mentioned that the time area before the time tp and the time area after the time tp can involve any given time areas. This means that also both time areas can reside in the past or the first time area in the past and the second actually in the future. The invention thus allows an installation operator also, within a process step or batch that lies in the past, to select a specific point in time, to select the corresponding learned SOMs for this process step or batch and then to look at how the temporal profiles after the point in time tp would develop based on the inventive method. He can subsequently compare these predicted profiles with the profiles that have actually occurred, in order in this way to develop a better understanding for the historical process step or batch.

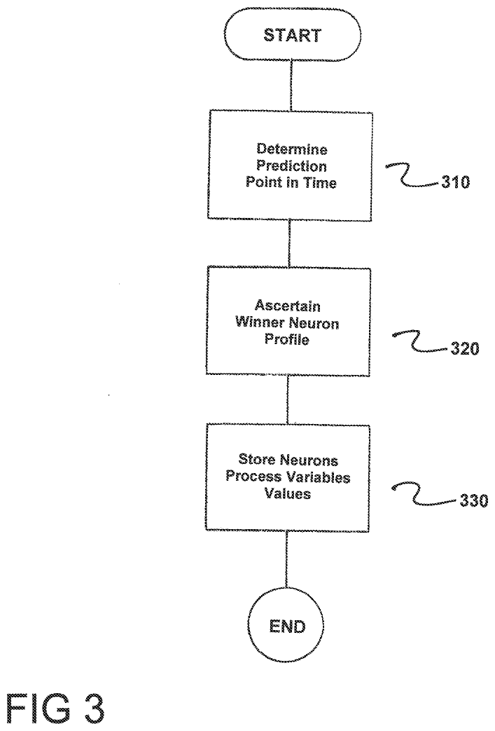

FIG. 3 is a flowchart of the method for predicting the operation of a technical installation in which a process engineering process having at least one process step is executing, where data sets characterizing the operation of the technical installation with values of process steps L, T, F are acquired in a time dependent manner and are stored in a data memory, where historical data sets are utilized during a learning phase to train a self-organizing map (SOM) for each process step or batch, where threshold values and associated tolerances are ascertained for each neuron and stored for each SOM symptom, and where all permitted temporal profiles of winner neurons are ascertained and stored for each process step or batch for all time stamps.

The method comprises determining, during an evaluation phase, a point in time tp, starting from which a prediction of the operation of the technical installation is to occur, as indicated in step 310.

Next, current data sets of the at least one process step are utilized to subsequently ascertain at least one winner neuron profile for an entirety of the process step or batch via learned winner neuron profiles, as indicated in step 320.

Next, values of the process variables in the neurons of the ascertained at least one winner neuron profile are stored after the previously determined point in time tp is displayed as a predicted profile on a display unit B, as indicated in step 330.

Thus, while there have been shown, described and pointed out fundamental novel features of the invention as applied to a preferred embodiment thereof, it will be understood that various omissions and substitutions and changes in the form and details of the methods described and the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1.-12. (canceled)

13. A method for predicting operation of a technical installation in which a process engineering process having at least one process step is executing, data sets characterizing the operation of the technical installation with values of process steps being acquired in a time-dependent manner and being stored in a data memory, historical data sets being utilized during a learning phase to train a self-organizing map for each process step or batch, threshold values and associated tolerances being ascertained for each neuron and stored for each SOM symptom, and all permitted temporal profiles of winner neurons being ascertained and stored for each process step or batch for all time stamps, the method comprising:
determining, during an evaluation phase, a point in time, starting from which a prediction of the operation of the technical installation is to occur;
utilizing current data sets of the at least one process step, to subsequently ascertain at least one winner neuron profile for an entirety of the process step or batch via learned winner neuron profiles; and
storing values of the process variables in the neurons of the ascertained at least one winner neuron profile after the previously determined point in time is displayed as a predicted profile on a display unit.

14. The method as claimed in claim 13, wherein symptom tolerances of the at least one winner neuron profile previously ascertained are utilized in the display as an uncertainty of the predicted profile.

15. The method as claimed in claim 13, wherein a most probable of the winner neuron profiles is determined, with a number of winner neuron profiles ascertained in the evaluation phase, by ascertaining symptoms of all previous time stamps of the process step or batch and is utilized to display the predicted profile.

16. The method as claimed in claim 14, wherein a most probable of the winner neuron profiles is determined, with a number of winner neuron profiles ascertained in the evaluation phase, by ascertaining symptoms of all previous time stamps of the process step or batch and is utilized to display the predicted profile.

17. The method as claimed in claim 13, wherein, instead of the symptom threshold values or in addition to the symptom threshold values, quantization errors are ascertained via training data and utilized in an evaluation to ascertain the most probable winner neuron profile.

18. The method as claimed in claim 14, wherein, instead of the symptom threshold values or in addition to the symptom threshold values, quantization errors are ascertained via training data and utilized in an evaluation to ascertain the most probable winner neuron profile.

19. The method as claimed in claim 15, wherein, instead of the symptom threshold values or in addition to the symptom threshold values, quantization errors are ascertained via training data and utilized in an evaluation to ascertain the most probable winner neuron profile.

20. The method as claimed in claim 15, wherein a union set of all symptom tolerances of all winner neuron profiles of the process step or batch ascertained during the evaluation phase is utilized as an uncertainty of the predicted profile.

21. The method as claimed in claim 16, wherein a union set of all symptom tolerances of all winner neuron profiles of the process step or batch ascertained during the evaluation phase is utilized as an uncertainty of the predicted profile.

22. The method as claimed in claim 13, wherein a point in time is defined, at which the prediction of the operation of the technical installation is to end.

23. The method as claimed in claim 13, wherein a configurable selection of the predicted temporal profiles of the process variables together with at least one of (i) step identifiers, (ii) anomalies and (iii) symptoms, is shown at the same time and/or in correlation with one another on the display unit.

24. A system for predicting operation of a technical installation, in which a process engineering process with at least one process step is executing, the system comprising:
a training unit for training self-organizing maps utilizing historical data sets with values of process variables ascertained as a function of time which characterize operation of the installation;
a memory for storing SOMs, of threshold values, tolerances and further data;
an evaluation unit for evaluating current data sets of a process step or batch aided by the self-organizing maps trained in the learning phase;
wherein the system is configured to:
determine, during an evaluation phase, a point in time, starting from which a prediction of the operation of the technical installation is to occur;
utilize current data sets of the at least one process step, to subsequently ascertain at least one winner neuron profile for an entirety of the process step or batch via learned winner neuron profiles; and
store values of the process variables in the neurons of the ascertained at least one winner neuron profile in the memory after the previously determined point in time is displayed as a predicted profile on a display unit.

25. The system as claimed in claim 24, further comprising one of (i) a display for display and output of the predicted temporal profiles ascertained via the evaluation unit and (ii) at least one interface for connection to the display for display and output of the predicted temporal profiles ascertained via the evaluation unit.

26. A computer program, in particular a software application, with program code instructions able to be executed by a computer for implementation of the method as claimed in claim 13, when the computer program is executed on the computer.

27. A non-transitory computer program product encoded with a computer program which is executable by the computer as claimed in claim 26.

28. The non-transitory computer program product as claimed in claim 13, wherein the non-transitory computer program product comprises a data medium or memory medium.

29. A graphical user interface, which is displayed on a display unit, and which is configured to display the predicted profiles of the system as claimed in claim 24.
